(19) United States
(12) Patent Application Publication
(10) Pub. No.: US 2005/0238365 A1
(43) Pub. Date: Oct. 27, 2005

(54) Optical encoder providing a wide range of resolutions

(76) Inventors: Boon Keat Tan, Tanjung Bungah (MY); Danny Moon Leong Low, Tmn Sri Nibong (MY); Chi Mun Ho, Seremban (MY); Colin Chong Hin Chee, Taman Pekaka (MY)

Correspondence Address: AGILENT TECHNOLOGIES, INC.;Legal Department, DL429, Intellectrual Property Administration, P.O. Box 7599, Loveland, CO, 80537-0599, US

(21) Appl. No.: 10/831,490

(22) Filed: Apr. 22, 2004

(51) Int. Cl. H04B 10/04

(52) U.S. Cl. 398/183

(57) ABSTRACT

An optical encoder comprises an encoder module, an interpolator module coupled to the encoder module, and a modulator module coupled to the interpolator module. The encoder generates a first and second position signals as a function of a light signal modulated by a code wheel. The interpolator module generates a first and second position signals having increased resolution as a function of said first and second position signals. The modulator module generates a first and second modulated position signals as a function of said first and second position signals having increased resolution.

### TECHNICAL FIELD

Embodiments of the invention pertain to an optical encoder which has a wide range of resolutions.

### BACKGROUND OF THE INVENTION

Optical encoders offer an inexpensive, accurate, and practical way to determine position, speed, and direction information. As such, optical encoders are utilized in a wide variety of applications. For example, printers often contain an optical encoder to determine the position of the paper being printed upon relative to the printhead. As the paper is fed through the printer, the optical encoder tracks and measures the longitudinal postion of the paper. The optical encoder provides an electrical signal indicating the paper's position so that the printer knows when to print, and the image is printed in the right place on the paper. In other applications, optical encoders are found in machine tools for machining of parts, motors to measure rates of rotation, and other industrial uses. Basically, optical encoders can be used by any application involving spinning or rotating parts which need to monitored or measured.

In many cases, an application requires position information over a wide range of operating speeds. For instance, for print applications, one printer might be a cheap, affordable, but slow printer, whereas another printer may be a fast, expensive, commercial printer. Some printers even have the ability to let the user choose the print speed (e.g., faster low-res prints or slower high-res prints). Accordingly, the optical encoder should have multiple resolutions to effectively accomodate the different print speeds. In the case for machine tools, the drill speed may be drastically increased or decreased, depending on the specific materials, finishes, tolerances, designs, etc. It is important that the optical encoder supports different resolutions to handle the wide range of possible operating speeds. Furthermore, it would be preferable if the same optical encoder could be used across different applications. Being able to use the same optical encoder across a wide array of products would greatly increase the commercial success of that optical encoder. And having different resolutions enables that optical encoder to meet the goal of adapting to different markets.

One prior art method for providing different resolutions entails the use of an interpolator. Basically, the interpolator multiplies the frequency of the optical encoder's base counts per revolution (CPR) by a pre-determined factor. This produces a different resolution other than that of the basic CPR resolution. Unfortunately, the interpolator offers only a limited number of fixed resolutions. One could implement multiple interpolators, but this would increase costs, and besides which, the additional interpolators are restricted to providing fixed multiples of the base CPR as additional resolutions. Finer resolutions inbetween the fixed multiples are not possible by using interpolators.

### SUMMARY OF THE INVENTION

Embodiments of the invention pertain to an optical encoder. The optical encoder includes a first circuit which generates an analog signal. The analog signal contains position information. A second circuit takes the analog signal and generates a first digital signal at a first frequency. The first frequency is an integer multiple of the frequency of the analog signal. A third circuit takes the first digital signal and generates a second digital signal but at a second frequency. The second frequency is the first frequency divided by an integer value. By selectively changing the integer multiple and integer value, a wide range of different resolutions can be achieved by the optical encoder.

### BRIEF DESCRIPTION OF THE DRAWINGS

FIG. 1 shows an exemplary optical encoder according to the conventional art.

FIG. 2 shows a block diagram of an optical encoder, in one embodiment in accordance with the invention.

FIG. 3A shows a flow diagram of a process performed by an exemplary encoder module.

FIG. 3B shows a flow diagram of a process performed by an exemplary interpolator module.

FIG. 3C shows a flow diagram of a process performed by a modulator module, in one embodiment in accordance with the invention.

FIG. 4A shows a block diagram of a modulator module, in accordance with one embodiment of the invention.

FIG. 4B shows a timing diagram illustrating an exemplary operation of a modulator module, in accordance with one embodiment of the invention.

FIG. 5A shows a block diagram of a one-shot pulse module, in accordance with one embodiment of the invention.

FIG. 5B shows a timing diagram illustrating an exemplary operation of a one-shot pulse module, in accordance with one embodiment of the invention.

### DETAILED DESCRIPTION

Referring to FIG. 1, an exemplary optical encoder upon which embodiments of the present invention can be practiced is shown. As depicted in FIG. 1, the optical encoder includes a rotating code wheel 110, a shaft 120 and a measurement circuit 130. The shaft 120 is coupled between a device (e.g., paper feed roller in a printer) and the code wheel. The device causes the shaft 120 to rotate the code wheel 110.

The code wheel 110 has a grating of alternating transmissive sections and non-transmissive (or reflective) sections. The measurement resolution is derived from the grating dimensions of the code wheel 110. When light emitted by the measurement circuit 130 is projected through or reflected by the rotating code wheel 110, the intensity of the light will be modulated by the rotating code wheel 110 as a function of the gratings. The modulated intensity of the light is detected by a receiver in the measurement circuit 130. The modulation rate is at the base resolution, measured in cycles per revolution (CPR), of the optical encoder.

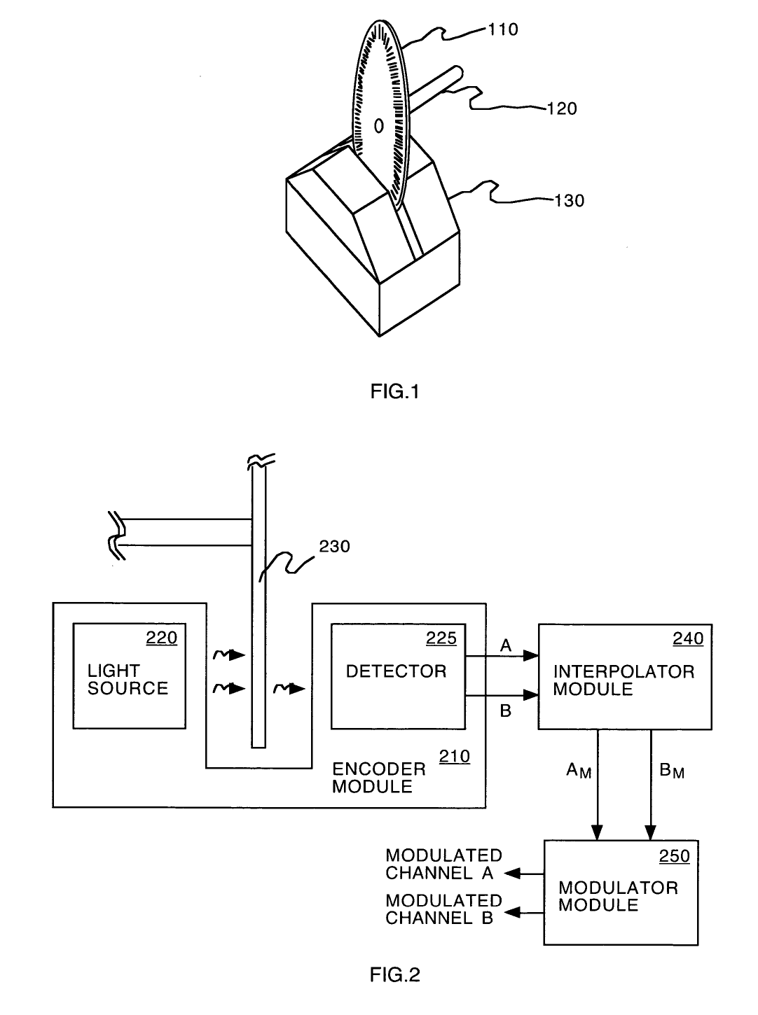

Referring now to FIG. 2, a block diagram of an optical encoder, in one embodiment in accordance with the invention, is shown. As depicted in FIG. 2, the optical encoder includes an encoder module 210, a code wheel 230, an interpolator module 240 and a modulator module 250. The encoder module 210 includes a light source 220 and a detector 225. The light from the light source 220 is modulated (e.g., intensity) by the code wheel 230. The intensity modulate light is received by the detector 225. In one implementation the light source 220 may be a light emitting diode (LED). The light source 220 may also include one or more lenses, gratings or the like for columnating the light. The detector 225 may be one or more photodiodes or the like.

The code wheel 230 has an alternating grating of transmissive sections and non-transmissive (or reflective) sections. When light is projected through or reflected by the rotating code wheel 230, the intensity of light passing through it will vary as a function of the gratings, the position of the code wheel 230 and direction of rotation of the code wheel 230. The measurement resolution is derived from the grating dimensions of the code wheel 230.

The encoder module 230 generates a time varying analog (e.g., sine wave, triangle wave, or the like) electrical signal (e.g., voltage or current) that varies in proportion to the modulated intensity of the light received at the detector 225. The output typically comprises a first and second analog position signals A, B, wherein the two output position signals are generated in quadrature (e.g., sine and cosine) with respect to each other. The modulation rate is at the base resolution of the device, or cycles per revolution (CPR).

The interpolator module 240 generates digital electrical signals having a frequency that is a multiple of the first and second analog position signals A, B provided by the encoder module 210. The interpolator module 240 is utilized to increase the resolution by effectively increasing the CPR over the base resolution. The interpolator module 240 receives the first and second quadrature analog position signals A, B from the encoder module 210. The interpolator module 240 generates a first and second digital quadrature position signals having increased resolution A_{M}, B_{M} as a function of the first and second quadrature analog position signals A, B. The interpolator module 240 may also generate one or more sets of digital quadrature position signals having increased resolution as a function of the first and second quadrature analog position signals A, B, wherein each set is a different multiple of the base resolution.

In an exemplary implementation, the interpolator module 210 compares the analog input position signals A, B from the detector module 220 with a threshold levels via a comparator circuit and generates a square wave (e.g., digital signal) having a period equal to the cyclical variation of the respective analog position signal A, B. Edge triggering is then utilized to generate four distinct quadrants in the cyclic output. By monitoring the rising edges of these signals, four positions per cycle are distinctly identified. In this way, a 4-fold increase over the base device resolution is realized. In another exemplary implementation, trigonometry can be utilized to resolve each cycle of the analog position signals A, B into finer and finer position information. The tan-1 function can be utilized to determine the angular position within each cycle of the analog position signals A, B. A set of quadrature digital position signals A_{M}, B_{M} that toggle as a function of the determined angular position are generated as outputs. Depending upon the accuracy of the interpolator module implementation, each cycle of the input analog position signals A, B can be subdivided substantially (e.g., increase of 1000 times or more).

The modulator module 250 provides an increased range of resolutions over the range provided by the interpolator. The modulator module 250 divides the digital quadrature position signals having increased resolution A_{M}, B_{M} by a specified value. If the interpolator module 240 provides two or more set of digital quadrature position signals having increased resolution, each set is divided down by the modulator module 250. For example, prior solutions utilize multiple interpolation factors to achieve a limited range of resolutions. Assuming that the base CPR of 180, a prior art solution applying multiple interpolator factors of 3 times and 5 times provides resolutions of 180, 540 and 900 CPR. An optical encoder providing a single interpolation factor of 5 times coupled to modulator module of the present invention provides resolutions of 900 (e.g., base multiplied by 5 times provided by interpolator module), 450 (e.g., output of interpolator divided by 2), 300 (e.g., output of interpolator module divided by 3), 180 (e.g., base) CPR. If the modulator module of the present invention is coupled to a multiple interpolator module (e.g., 3 times and 5 times), the resolution range spans between 900, 540, 450, 300, 270, 180 and 108 CPR.

Upon dividing the digital quadrature position signals having increase resolution A_{M}, B_{M}, the modulator module 240 provides a first and second modulated position signals A_{M/N}, B_{M/N} having a selected resolution at its outputs. Accordingly, the invention in accordance one embodiment provides resolution specific position signals that may be selected for the particular application.

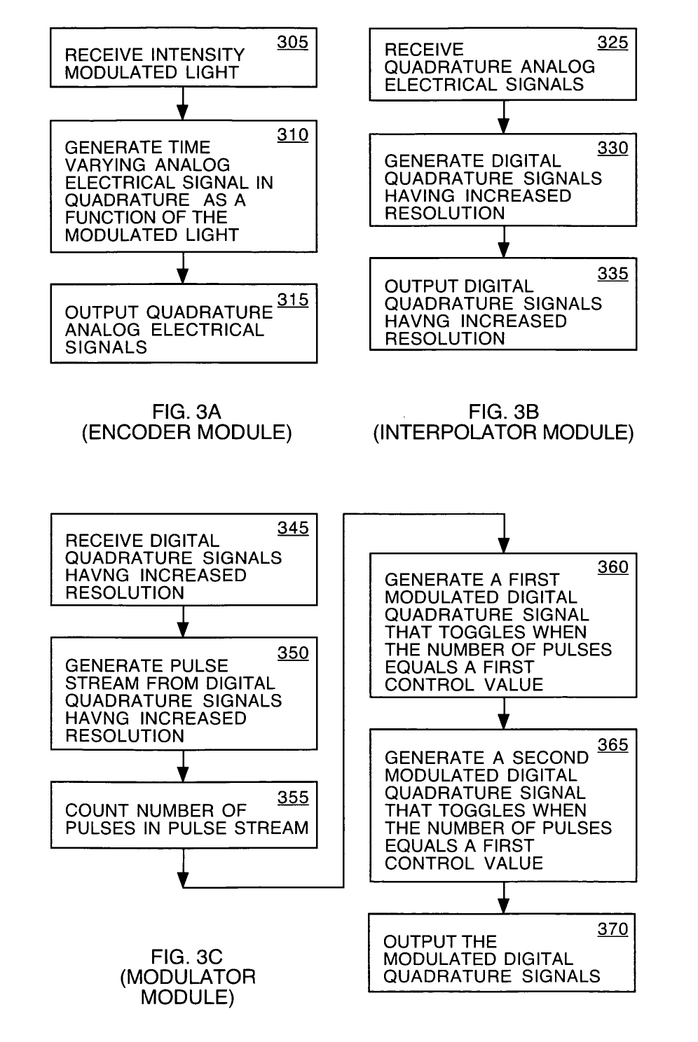

Referring now to FIG. 3A, a flow diagram of a process performed by an exemplary encoder module, is shown. As depicted in FIG. 3A, the process begins with receiving intensity-modulated light, at 305. At 310, a first and second time varying analog electrical signal (e.g., voltage or current) are generated in quadrature (e.g., shifted by 90° with respect to each other), as a function of the received intensity modulated light. At 315, the first and second quadrature analog electrical signals, A and B position signals, are output.

Referring now to FIG. 3B, a flow diagram of a process performed by an exemplary interpolator module, is shown. As depicted in FIG. 3B, the process begins with receiving a first and second position signals A, B, at 325. At 330, a first and second digital quadrature electrical signals A_{M}, B_{M} providing increased resolution, are generated as a function of the received first and second position signals A, B respectively. At 335, the first and second position signals having increased resolution A_{M}, B_{M} are output.

Referring now to FIG. 3C, a flow diagram of a process performed by a modulator module, in one embodiment in accordance with the invention, is shown. As depicted in FIG. 3C, the process begins with receiving a first and second position signals having increased resolution A_{M}, B_{M}, at 345. At 350, a pulse stream is generated from the first and second digital quadrature position signals having increased resolution A_{M}, B_{M}. In one implementation, each raising and falling edge of the first and second digital quadrature position signals A_{M}, B_{M} triggers generation of a pulse in the pulse stream. At 355, the number of pulses in the pulse stream is counted. At 360, a first modulated digital position signal is generated A_{M/N}, B_{M/N} when the number of pulses equals a first control value. In one implementation, the first modulated digital position signal A_{M/N} is generated by toggling from the current logic level to the other logic level when the count equals the first control value. The first control value is set to twice the desired modulating factor. At 365, a second modulated digital position signal B_{M/N} is generated when the number of pulses equals a second control value. The second control value is set to the desired modulating factor. At 370, the first and second modulated digital quadrature position signals A_{M/N}, B_{M/N} are output.

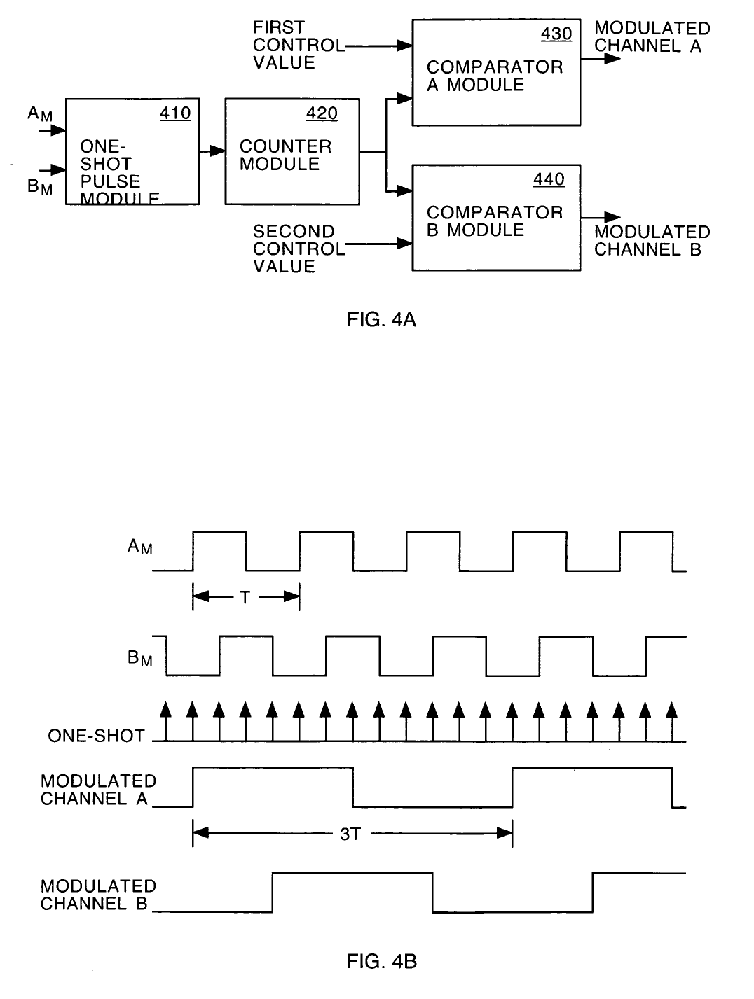

Referring now to FIG. 4A, a block diagram of a modulator module, in accordance with one embodiment of the invention, is shown. As depicted in FIG. 4A, the modulator module includes a one-shot pulse module 410, a counter module 420, a comparator A module 430 and a comparator B module 440. The one shoot pulse module receives a first digital quadrature position signal having increased resolution A_{M} at a first input and second digital quadrature position signal having increased resolution B_{M} at a second input. The one shoot pulse module 410 generates a series of pulses, one for each of the rising and falling edges of both the first and second digital quadrature position signals having increased resolution A_{M}, B_{M}.

The counter module 420 receives the series of pulses from the one shoot pulse generator 410. In one implementation, the counter module 420 comprises a digital counter. The counter module 420 counts the number of pulses output by the one shot pulse module 410 and outputs a binary representation of the count on a plurality of outputs.

The comparator A module 430 receives a first control value on a first set of inputs and the count value, from the counter module 420, on a second set of inputs. The comparator A module 430 generates a modulated position signal A_{M/N} that toggles states each time the count value on the second set of inputs is equal to the first control value on the first set of inputs. The comparator B module 440 receives a second control value on a first set of inputs and the count value from the counter module 420 on a second set of inputs. The comparator B module 440 generates a modulated position signal B_{M/N} that toggles states each time the count value on the second set of inputs is equal to the second control value on the first set of inputs. Accordingly, the first and second modulated position signals A_{M/N}, B_{M/N} are generated in quadrature relationship to each other. (e.g., shifted with respect to each other). In one implementation, the count module is reset each time the first modulated position signal A_{M/N} toggles.

As depicted in FIG. 4B, a timing diagram illustrating an exemplary operation of a modulator module, in accordance with one embodiment of the invention, is shown. The timing diagram illustrates division by three of the first and second quadrature position signals having increase resolution A_{M}, B_{M}. The first and second position signals having increase resolution A_{M}, B_{M} are processed by the one-shot pulse module to generate the one shot signal comprising a stream of pulses. Each pulse in the one shot signal corresponds to a rising or falling edge of the first and second position signal having increased resolution A_{M}, B_{M}. To divide by three, a first control value of 6 (e.g., twice the desired divisor) is input to the comparator A module 430 and a value of 3 is input to the comparator B module 440. Therefore, after six pulses the count value generated by the counter module 420 is equal to 6 and the modulated position signal A_{M/N} toggles. After three pulses the count value generated by the counter module 420 is equal to 3 and the modulated position signal B_{M/N} toggles.

Accordingly, the first modulated position signal A_{M/N} pulses every 2N times, where N is the modulating factor, and the second modulated position signal B_{M/N} pulses every 2N±N times. The plus/minus sign on the second modulated position signal B_{M/N} determines the direction of movement (e.g., whether B lags A or vice versa).

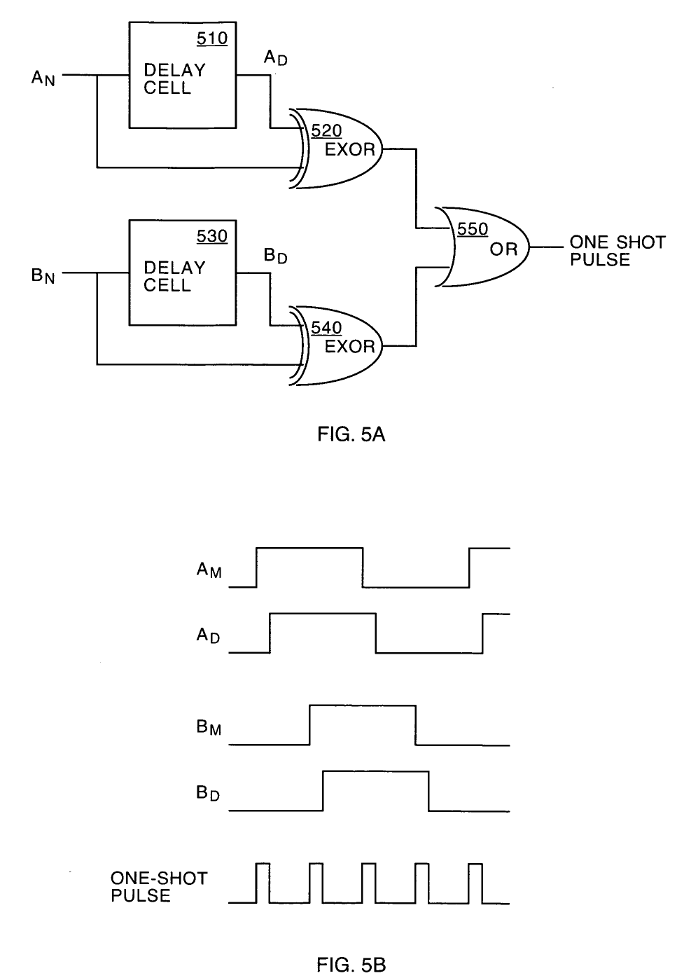

Referring now to FIG. 5A, a block diagram of a one-shot pulse module, in accordance with one embodiment of the invention, is shown. As depicted in FIG. 5A, the one shot pulse module includes a first delay cells 510, a second delay cell 530, a first exclusive-or (EXOR) gate 520, a second EXOR gate 530 and an or (OR) gate 550. The first delay cell 510 receives a first quadrature position signal having increased resolution A_{M} and introduces a small time shift to generate a first delayed signal A_{D}. The delay cells may be a resistor-capacitor circuits, data flip flops or the like. If the delay cells are implemented by a data flip flop, the data flip flop is clocked at least twice as fast and the frequency of the first quadrature position signal having increased resolution AM.

The first EXOR gate 520 receives the first delayed signal A_{D} at a first input and the first position signal having increased resolution A_{M} at a second input. The output of the first EXOR gate 520 is low if both input signals are high or low. The output of the first EXOR gate 520 is high if one input signal is high and the other input signal is low. Thus, the output of the first EXOR gate 520 is a series of pulses corresponding to the rising and falling edge of the first quadrature position signal having increased resolution A_{M}.

The second delay cell 530 and the second EXOR gate 540 operates on the second quadrature position signal having increased resolution B_{M} as described above with respect to the first quadrature position signal having increased resolution A_{M}. The pulse streams output by the first EXOR gate 520 and the second EXOR gate 540 are summed by the OR gate 550. Hence, the output of the OR gate 550 is a stream of pulses, wherein each pulse corresponds to a rising or falling edge of either the first of second quadrature position signals having increased resolution A_{M}, B_{M}. As depicted in FIG. 5B, a timing diagram illustrating an exemplary operation of a one-shot pulse module, in accordance with one embodiment of the invention, is shown.

Embodiments in accordance with the invention are advantageous in that the optical encoder has a wide range of resolutions. The wide range of resolutions may be readily utilized in applications that required a range of accuracies (e.g., broad, average, fine), operating speed (e.g., high, medium, low) and/or the like.

The foregoing descriptions of specific embodiments in accordance with the invention have been presented for purposes of illustration and description. They are not intended to be exhaustive or to limit the invention to the precise forms disclosed, and obviously many modifications and variations are possible in light of the above teaching. The embodiments in accordance with the invention were chosen and described in order to best explain the principles of the invention and its practical application, to thereby enable others skilled in the art to best utilize the invention and various modifications as are suited to the particular use contemplated. It is intended that the scope of the invention be defined by the Claims appended hereto and their equivalents.

1. An optical encoder comprising:
a first circuit for generating an analog signal containing position information;
a second circuit coupled to said first circuit which generates a first digital signal at a first frequency as a function of said analog signal, said first frequency being an integer multiple of a frequency of said analog signal;
a third circuit coupled to said second circuit which generates a second digital signal at a second frequency, said second frequency being said first frequency divided by an integer value, wherein different resolutions can be produced by selectively setting said integer multiple and said integer value.

2. The optical encoder according to claim 1, wherein said first circuit comprises:
a light source;
a code wheel for modulating light emitted by said light source;
a detector which converts said light modulated by said code wheel into said analog signal, wherein said analog signal comprises a time varying anolog electrical signal.

3. The optical encoder according to claim 1, wherein said second circuit comprises an interpolator.

4. The optical encoder according to claim 3, wherein said interpolator multiplies a frequency of said analog signal by an integer value to produce said first frequency of said first digital signal.

5. The optical encoder according to claim 1, wherein said third module comprises a modulator module comprising:
a one shot clock for generating one shot pulses;
a counter having an input coupled an output of said one shot clock;
a first comparator having a first input for receiving a first control signal and a second input coupled to an output of said counter; and
a second comparator having a first input for receiving a second control signal and a second input coupled to said output of said counter.

6. The optical encoder according to claim 5, wherein said one shot pulse module generates a pulse for each raising edge and each falling edge of said first control signal and said second control signal.

7. The optical encoder according to claim 5, wherein said one-shot clock comprises:
a first delay cell that generates a first delayed signal as a function of said first control signal;
a first exclusive-or gate for receiving said first control and said first delayed signal and which generates a first set of pulses;
a second delay cell that generates a second delayed signal as a function of said second control signal;
a second exclusive-or gate for receiving said second control signal and said second delayed signal and which generates a second set of pulses;
an OR gate for summing said first and second sets of pulses.

8. The optical encoder according to claim 1, wherein said first circuit outputs two analog signals which are shifted by ninety degrees with respect to each other.

9. The optical encoder according to claim 8, wherein said second circuit outputs two digital signals which are shifted by ninety degrees with respect to each other.

10. The optical encoder according to claim 9, wherein said third circuit outputs two digital signals which are shifted by ninety degrees with respect to each other.

11. A method of determining position information comprising:
emitting a light;
modulating said light;
converting modulated light into an analog signal at a first frequency;
converting said analog signal into a first digital signal, wherein said first digital signal has a first frequency which is an integer multiple a frequency corresponding to said analog signal;
generating a second digital signal as a function of said first digital signal, wherein said second digital signal has a second frequency, said second frequency being said first frequency divided by an integer value.

12. The method according to claim 11 further comprising the step of selectively setting said integer mulitple and said integer value to produce a desired output resolution.

13. The method according to claim 11 further comprising:
generating a pulse stream as a function of said first digital signal;
counting a number of pulses in said pulse stream;
generating a first modulated position signal by toggling between a first state and a second state when said number of pulses is equal to a first control value; and
generating a second modulated position signal by toggling said first state and said second state when said number of pulses is equal to a second control value.

14. The method according to claim 13, wherein said first control value is equal to twice a modulating factor and said second control value is equal said modulating factor.

15. The method according to claim 13, wherein said first modulated position signal and said second modulated position signal comprise quadrature signals.

16. An optical encoder comprising:
a light source for emanating light;
a code wheel which modulates said light from said light source as said code wheel revolves;
a detector which generates an electrical analog signal as a function of modulated light;
an interpolator coupled to said detector which converts said analog signal into a first digital signal having a first fequency, wherein said first frequency is an integer multiple X of a frequency of said analog signal;
a modulator coupled to said interpolator for outputting a second digital signal at a frequency which divided by an integer value N.

17. The optical encoder according to claim 16, wherein said analog signal corresponds to a base count per revolution.

18. The optical encoder according to claim 17, wherein said base count per revolution is 180.

19. The optical encoder according to claim 16, wherein X comprises 3 or 5 and N comprises 2, 3, or 5.

20. The optical encoder according to claim 19, wherein output from said modulator include resolutions of 180, 108, 270, 300, 450, 540, and 900 counts per revolution.
